(19) United States
(12) Patent Application Publication
(10) Pub. No.: US 2007/0119094 A1
(43) Pub. Date: May 31, 2007

(54) Mole gun

(76) Inventor: Gerald Ouzts, Russellville, AR (US)

Correspondence Address: POSZ LAW GROUP, PLC, 12040 SOUTH LAKES DRIVE, SUITE 101, RESTON, VA, 20191, US

(21) Appl. No.: 11/288,169

(22) Filed: Nov. 29, 2005

(51) Int. Cl. A01M 27/00

(52) U.S. Cl. 43/84

(57) ABSTRACT

A device for exterminating molds that is arranged to fire a projectile into a mole as the mole moves within mole tunnel. The device holds an explosive charge and a projectile and is arranged in a location about the mole tunnel. The device includes a trigger that detects the presence of a mole. When the presence of a mole is detected, the explosive charge is ignited or released forcing the projectile into the mole. The device can be self-contained or include parts for adapting a spear mole trap to include a barrel assembly including an explosive charge and a projectile, and associated structures.

### BACKGROUND OF THE INVENTION

The invention encompassed by the embodiments described in this application relates generally to a device for efficiently and effectively killing and exterminating moles that includes firing a projectile into the mole. Moles can be a nuisance by digging tunnels in lawns, golf courses, gardens, etc. in search of their main food source, worms. Moles can excavate 12-15 feet of tunnel per hour. When excavating, moles use their powerful front paws to push the dirt outward from the tunnel, which includes creating dirt piles above the ground surface that are clearly visible. The resulting mole tunnels can undermine and damage lawns, concrete slabs, driveways, pools, and even shallow foundations. Extensive mole tunnel networks can cause severe damage to a lawn requiring expensive repairs that can include tilling and replanting of an entire lawn.

A plunger- or spear-type trap (or simply “spear mole trap”) is shown in FIG. 6. The trap shown in FIG. 6 includes setting tee 101, a chain 102, a safety pin 103, legs 104, a trigger latch 105, a spear plate 106, a trigger pan lip 107, a trigger pan 108, spines 109, and a spring (not numbered). To set the plunger- or spear-type trap shown in FIG. 6, a user makes a depression with his/her thumbs or hand in the center of an active mole tunnel. The trigger pan can be arranged ½ to 1 inch down in this depression or blockage by pushing the trigger pan downward, which can be accomplished when engaging or setting the trap. The user positions the trap over the depression with the legs straddling the tunnel. The trap is pushed into the soil until the trigger pan lays flat on top of the depression. The trigger latch is lifted and the trigger pan is pushed into the tunnel depression. The trigger latch should lie outside of the trigger pan lip. Holding the frame of the trap firmly with one hand, the second hand pulls upward on the setting tee, so that the latch slides into position inside of the pan lip, holding the plate and spikes above the tunnel. FIG. 7 shows the trap of FIG. 6 set in a shallow mole tunnel.

A disadvantage with the plunger- or spear-type trap is the need to preset the tines or spikes. The tines or spikes can impale the user, if the trap is mishandled, or if the trap slips during setting. Further, the plunger- or spear-type trap requires a strong spring for forcing the tines or spikes downward into the mole. Accordingly, setting the trap necessitates overcoming or struggling with the strong spring. An additional disadvantage of the plunger- or spear-type trap is that it can be ineffective in killing the mole. For example, the plunger- or spear-type trap can impale a mole without immediately killing the mole. This causes the mole a great amount of suffering and cruelty prior to death.

### SUMMARY OF INVENTION

Objectives and features of the embodiments described in this application include use of a projectile, such as a bullet or pellet, driven by an explosive force to kill a mole. The mole gun described in this application can be easy and inexpensively manufactured.

### BRIEF DESCRIPTION OF THE DRAWINGS

FIG. 1 is a side view of an embodiment within the scope of this patent application prior to being armed or set.

FIG. 2 is a partial perspective view of an embodiment within the scope of this patent application in an armed or set position.

FIGS. 3A and 3B are enlarged cross-sectional side views of a first representative barrel assembly in accordance with the scope of this patent application.

FIG. 4 is an enlarged cross-sectional side view of a representative second barrel assembly in accordance with the scope of this patent application.

FIG. 5 is an enlarged cross-sectional side view of a third representative barrel assembly in accordance with the scope of this patent application.

FIG. 6 is a side view of a plunger- or spear-type trap prior to being armed or set.

FIG. 7 is a side view of a plunger- or spear-type trap in an armed or set position.

### DESCRIPTION OF THE PREFERRED EMBODIMENTS

The following embodiments and aspects thereof are described and illustrated in conjunction with structures and methods that are meant to be exemplary and illustrative, and not limiting in scope. In various embodiments, one or more of the above-described problems with plunger- or spear-type traps are reduced or eliminated, while other embodiments are directed to other improvements.

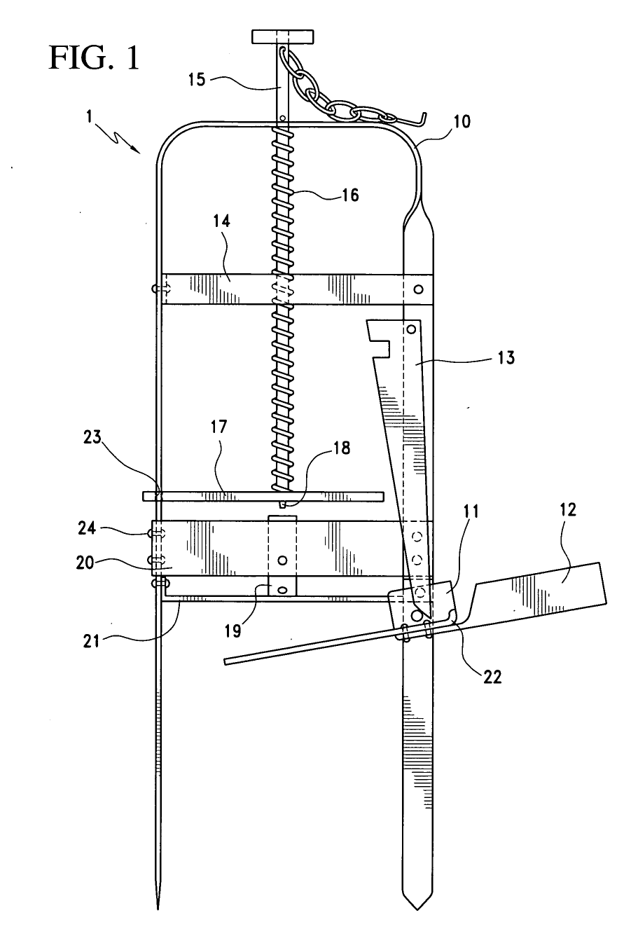

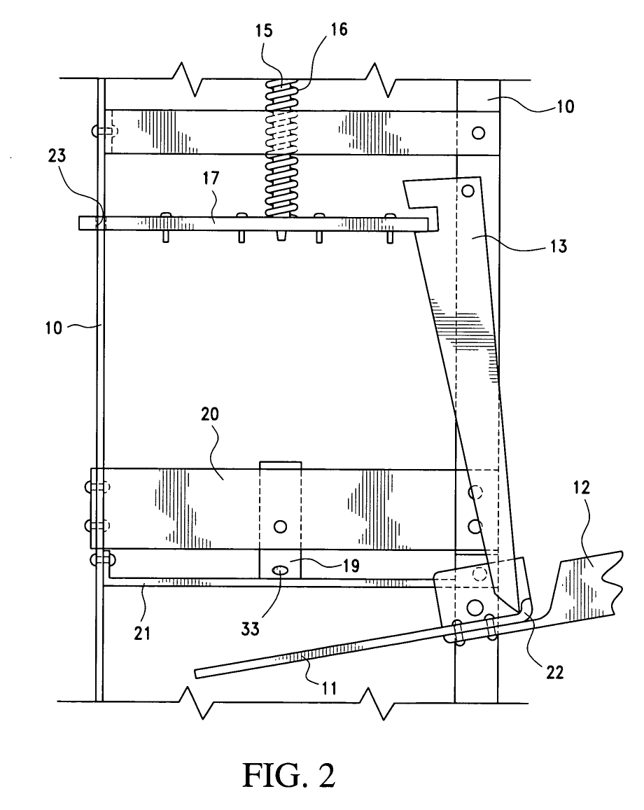

Representative mole guns as described this application are shown in FIGS. 1 and 2. FIG. 1 shows a mole gun prior to being armed or set. FIG. 2 shows a mole gun in an armed or set position. In the following descriptions, the same reference numbers have been used to identify the structures shown in FIGS. 1-5. Different configurations, structures or embodiments of the various elements shown in these figures can be used in other of the embodiments of the present application shown in these figures. In addition, the embodiments and aspects of the invention described in this application are described and illustrated in conjunction with various structures that are meant to be exemplary and illustrative, and not limiting in scope. In any of the various embodiments, modification or use of different structures to obtain the same functionality can be employed within the scope of the invention described herein.

The device in FIG. 1 includes a frame 10 having upper and lower sections. The frame can be made of any suitable material (i.e., metal, reinforced plastic) that has sufficient strength to support the components fixedly and slidably attached thereto as described in this application. For example, the frame can be formed from a flat elongated piece of metal into the shape shown in FIG. 1. FIG. 1 shows right and left legs of the frame perpendicular to each other. While other arrangements can be used, this arrangement provides a frame with stability when inserted into the ground. The lower section of the frame or the bottom ends of the frame in particular can be pointed for easier insertion into the ground.

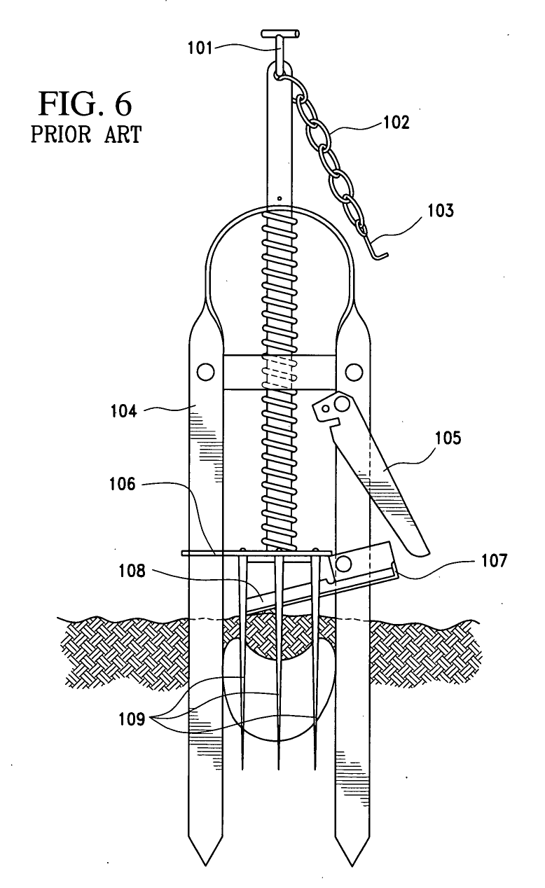

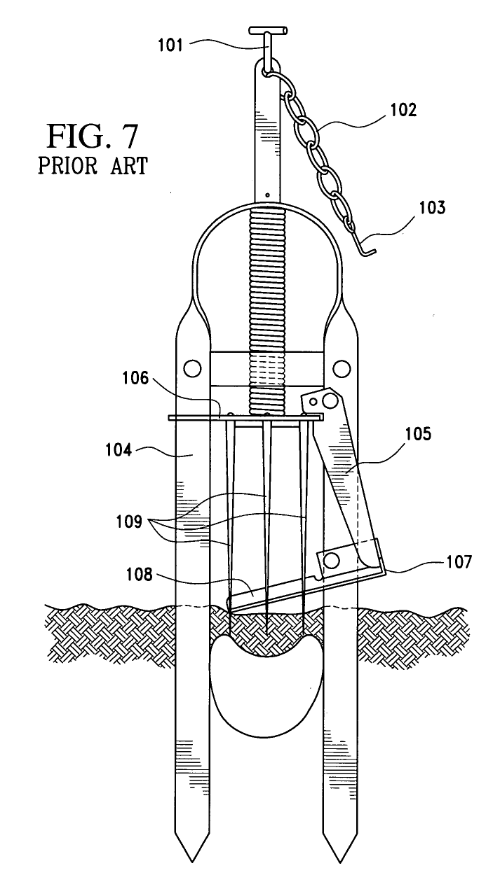

Generally, the mole gun described in this application can be inserted into the ground in the same manner as that for the plunger- or spear-type trap shown in FIGS. 6 and 7. In a useful arrangement, the frame 10 can have a height approximately three times longer than its width and/or depth, although many other arrangements can also be used and adapted for different situations.

A bar 15 can be arranged at a central location within the frame 10, such as relative to its width. The bar 15 can generally extend vertically and pass through the frame, such as at a upper middle portion thereof. The bar 15 can include holes, one of which accepts one end of a safety chain and another which accepts a safety pin. The safety pin is secured to another end of the safety chain. A handle can be arranged at an upper end of the bar 15. The handle and bar can form a T-shape. The handle eases the effort necessary when pulling the bar upward and engaging the trap. A guide plate 17 can be arranged at the bottom end of the bar 15. The guide plate can have an opening 23 therein (i.e., hole, slot, etc.), such as at one end thereof along the lines shown at 23 in FIGS. 1 and 2, that slides along the frame 10.

The opening 23 of the guide plate 17, by receiving or cooperating with the frame 10 of the mole gun 1, assists in controlling the sliding movement of the guide plate 17 and assuring that an impingement device 18 hits its target (an explosive device arranged in the barrel assembly 19), when the guide plate 17 moves downward. An impingement device 18, which can be configured as or to include a firing pin, is arranged on a bottom side of the guide plate and is typically arranged on the side of the guide plate opposite the bar 15. The barrel assembly 19 is secured to the frame 10 directly underneath the guide plate 17, so that the impingement device 18 (i.e., firing pin) of the guide plate 10 contacts the barrel assembly 19, when it is released from its armed or set position. The barrel assembly can be secured to the frame by using any suitable fastening devices. In the arrangement shown in FIGS. 1 and 2, braces or brackets 20, 21 are used to secure the barrel assembly 19 to the frame 10. Brace 14 can optionally be used to provide additional stability to the frame 10. The braces or brackets 14, 20, and 21 can be joined to the frame 10 and the barrel assembly 19 by any suitable securing devices, such as rivets 24, screws or other. The securing devices can include welding, brazing, gluing, or any other suitable joining means. The other various elements described in these embodiments, such as joining together the trip plate 11 and the extension therefor (i.e., trip plate extension 12), can be joined together in a similar manner.

In the embodiments shown in FIGS. 1 and 2, the mole gun 1 has a trigger mechanism for triggering the explosive charge. The trigger mechanism includes a trip plate 11, which can be generally an elongate plate, and a latch 13. The trip plate 11 includes a trip plate actuator 22. The mole gun described in this application can be inserted into the ground in the same manner as that for the plunger- or spear-type trap shown in FIG. 7. When in the armed position, such as shown in FIG. 2, the guide plate 17 is held in or by a notch (not numbered) provided in the upper portion of the latch 13, and the bottom tip of the latch 13 is held by the trip plate actuator 22. The guide plate 17 is biased or forced downward by spring 16 and/or by gravity. The downward force of the guide plate 17 against the bottom surface of the notch in the latch 13 forces the bottom tip of the latch 13 rightward and against trip plate actuator 22. The latch 13 is held in this position by the bottom tip of the latch 13 pressing against the trip plate actuator 22. The trip plate 11 and latch 13 are operably connected and movable relative to the frame 10 and barrel assembly 19, so that any upward force received by the trip plate 11 (i.e., the portion of the trip plate 11 arranged above the mole tunnel) causes of the front end of the trip plate 11 to pivot upwards, while the rear end of the trip plate pivots downward. The downward movement of the rear end of the trip plate 11 causes the bottom tip (or simply “bottom”) of the latch 13 to release from the trip plate actuator 22. When the latch 13 is released, the guide plate 17 is released and forced downward by spring 16 and/or gravity. Downward movement of the guide plate 17 causes the impingement device 18 to strike and detonate the explosive charge (i.e., bullet 22 as shown in FIG. 5) forcing a projectile (i.e., bullet 22 as shown in FIG. 5) out of the projectile bore 32 and into a mole.

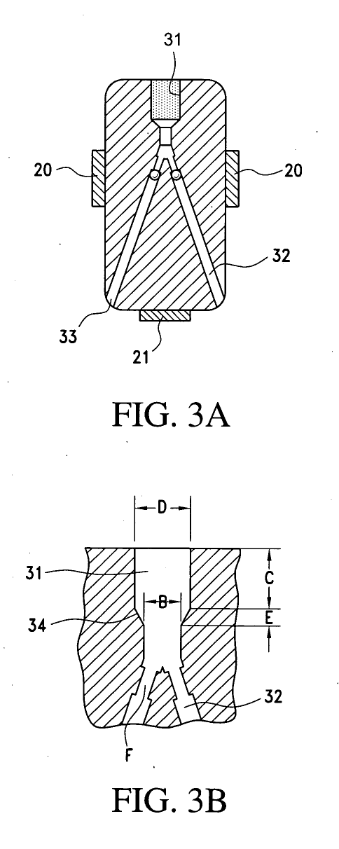

The barrel assembly 19 of the mole gun described in this application can be armed by placing an explosive charge in the explosion chamber 31 and arranging a projectile in the projectile bores 32, as shown in FIG. 3A. For example, the projectile can be inserted into the projectile bore 32 at opening 33 and held near the opening of the projectile bore 32 by friction against the surface of the projectile bore. Alternatively, the projectile can be moved or pushed into a position anywhere along the length of the projectile bore 32 from the opening 33 to the pellet stop F, such as shown in FIG. 3A. These procedures for arming the barrel assembly 19 can be carried out before or after arming or cocking the guide plate 17, which is described elsewhere in this application. More than one projectile can be inserted into a respective projectile bore 32. Generally in this application, expressions such as “loading,” “arming,” “setting,” “cocking,” etc. of the mole gun include both arming or loading the barrel assembly 19 and the setting or engaging of the trip plate 11 and the latch 13 in the set position, the latter which is shown in FIG. 2.

The trip plate extension 12 provides the mole gun as described in this application with advantages over the plunger- or spear-type trap shown in FIGS. 6 and 7. Many of the advantages of the trip plate extension 12 are concerned with safety. For example, the trip plate extension 12 can be used to assist in arming or cocking the mole gun. The device described in this application can be inserted into the ground in a manner similar to that for the plunger- or spear-type trap shown in FIGS. 6 and 7. Thereafter, one hand of the user can be used to move the guide plate 17/impingement device 18 into position. This can be accomplished by placing the thumb of the one hand of the user at the top of the frame 10, pulling the guide plate 17 upward by using a squeezing or pulling action; and once in position, using the fingertips of the one hand to engage or hold the edge of the guide plate 17/impingement device 18 in position. The other hand of their user can then lift the trip plate extension 12 and engage the trip plate actuator 22 of the trip plate 11 and the bottom tip of the latch 13. This procedure is safer than reaching inside the mole gun (i.e., underneath the area occupied by the barrel assembly 19) and engaging the trip plate actuator 22 with the bottom tip of the latch 18, where release of the guide plate 17 could cause the impinging device 18 to strike the explosive charge, thereby causing the explosive charge to explode and fire a projectile possibly into the user's hand.

The trip plate extension 12 can also be used to safely disarm or uncock the mole gun. For example, if the mole gun was loaded or armed but was not fired by action of a mole or otherwise, the safety pin can be inserted into the lower hole in the bar 15 to hold in place the bar 15 and the guide plate 17 attached thereto, and then the trip plate extension 12 can be moved downward to “uncock” or disarm the mole gun by releasing the bottom tip of the latch 13 from the trip plate actuator 22. Thereafter, the powder charge, projectiles, etc. can be safely removed; the safety pin can be removed from the bar 15; and the guide plate 17 returned to its released position.

As explained elsewhere in this application, when adapting or modifying a plunger- or spear-type trap to the mole gun described herein, the spring can be shortened, replaced with a weaker spring, or eliminated altogether. A reduced spring tension makes it easier to lift the guide plate 17/impingement device 18 by only using one hand.

Within the embodiments described in this application, an explosive charge is fired (exploded) to discharge a projectile, i.e., pellet or pellets, or snake shot. The explosive charge can include gunpowder, which may be the most convenient. However, other explosive charges or expanding sources can be used, such as pneumatic air, compressed air, or compressed carbon dioxide (CO₂) for forcing the projectile out of the projectile bore of the mole gun. A pneumatic-air source compresses a tiny bit of air by action of a pump lever in order to obtain the internal pressure needed to power the projectile out the projectile bore barrel at a decent pace. A disadvantage of the pneumatic air source may be the additional structure necessary and all the time and effort needed to obtain the necessary internal pressure. A barrel assembly using compressed air or CO₂ can be powered by a reservoir of compressed air or CO₂ arranged within the barrel assembly. The reservoir can be replaceable and self-contained or can be rechargeable by a larger container. The arrangements used in airguns for pneumatic air, compressed air, or compressed carbon dioxide (CO₂) can be adapted and used as the explosive or expansive force in the barrel assembly described this application for forcing the projectile out of the projectile bore of the mole gun.

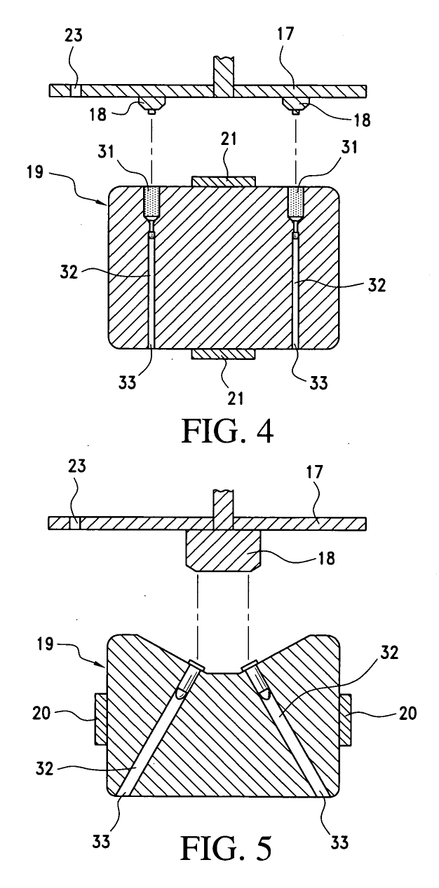

The barrel assemblies, such as shown in FIGS. 3A, 3B, and 4, can be constructed to separately hold an explosive charge and projectile. In an alternative arrangement, such as shown in FIG. 5, the explosive charge and the projectile can be combined together, such as in a bullet 24. A representative barrel assembly is shown in FIG. 3A and can be made of metal or other suitable material capable of withstanding the explosive charge detonated in the explosion chamber 31. The barrel assembly shown in FIG. 3A can be joined to the frame 10 by vertical bracket 20 and horizontal bracket 21. The barrel assembly shown in FIG. 3A includes an explosion chamber 31 that receives an explosive charge. The explosion chamber can have a stepped configuration, such as shown in FIG. 3B, for holding an explosive charge. For example, explosion chamber 31 can be designed accept an explosive charge for nailers, such as those sold by Remington.

An exemplary embodiment is shown in FIG. 3B, where the diameter of the upper bore “D” can be 0.224, 0.231, or 0.246 inches or other, and that of the lower bore “B” can be slightly smaller than D, such as 0.156 or 0.208 inches or other. The lower bore B can have a bore or diameter smaller than that of the upper bore D for holding an explosive charge therein. The depth of the upper bore “C” (i.e., the length from the upper surface of the barrel assembly to the top of the stepped portion 34) can be 0.230, 0.320, or 0.625 inches or other. The depth “E” (i.e., the length from the top of the stepped portion 34 to the bottom of the lower bore) can be 0.240 inches. In other arrangements, the stepped or tapered bore 34, as identified by dimension E in FIG. 3B, is not included and can be eliminated altogether. In such arrangements, the upper bore of the explosion chamber such as that defined by dimensions C and D, and the stepped or tapered bore such as that defined by dimensions B and E need not be present. In these arrangements, the projectile bore 32 is contiguous with and/or communicates directly with the explosion chamber 31.

The dimensions and configurations of the explosion chamber 31 can be adapted and modified to accept or hold any kind of explosive charge or bullet. Other diameters can be used for the upper bore D and the lower bore B, and other lengths can be used for the depth C of the upper bore and the depth E of the stepped portion 34. Such diameters and lengths can be adapted to different sized explosive charges and projectiles. For example, Remington brand is one brand of blank powder charge. These charges are the type used with nail guns or drivers used to drive anchors into concrete and steel. Another type of charge is the primer charge used in reloading shotgun shells. These primers are available from Winchester, Remington, Federal and CCI. Some designations for this type of primer are 209, 209M, 209P and 209A, depending on the manufacturer.

In the arrangements shown in FIGS. 3A, 3B, and 4, a reduced diameter portion is provided in the projectile bores 32. This reduced diameter portion is called a pellet stop F and can be located anywhere along the length of the projectile bore 32. In FIGS. 3A, 3B, and 4, a pellet stop F is provided at the end of the projectile bore 32 adjacent the explosion chamber 31 at the powder charge end of the barrel. The pellet stop F can have smaller than the diameter bore of the projectile bore 32. For example, for a 0.177 pellet, the projectile bore 32 for the pellet can be approximately 0.177, and the bore or diameter for the pellet stop can be approximately 0.156. Of course, other diameters can be used for the projectile bore and pellet stop to accommodate different sized projectiles, such as those discussed elsewhere in this application. A purpose of the pellet stop is to hold the projectile or pellet in place when the mole gun is in the armed or cocked position, while permitting the force resulting from detonation of the explosive charge, which is held in the explosion chamber 31 and detonated by the impingement device 18, to force the projectile out of the projectile bore with sufficient velocity for killing a mole.

The projectile bores 32 can be made of a size that accepts any caliber bullet or pellet, including those made by Crossman, Beeman, and Daisy. A representative caliber bullet or pellet is 0.17 or 0.22 caliber. The dimensions and configurations of the projectile bores 32 and pellet stops F can be adapted and modified to accept or hold any kind of projectile. Representative pellets that can be used in the mole gun described in this application include those for pellet guns and rifles that are available from several manufacturers. The manufacturers include Beemon, Gamo, Eun Jin, Daisy, and RWS. Bullets used to reload rifle cartridges and also be used. The calibers therefore can include 0.17 and 0.22 made by, for example, Homady, Winchester, CCI, Speer and Sierra. In addition, round ball buckshot pellets, for shot shell reloading, in various sizes (i.e., sized to match projectile bore 32) can be used in the mole gun of this application.

The effectiveness of the mole gun described in this application can be increased by including more than one projectile bore for firing multiple pellets with a single explosive charge. The effectiveness of the mole gun described in this application can be also increased by spacing the projectile bores 32 apart as shown in FIG. 4 or by arranging the projectile bores 32 to angle outwardly from a center top portion of the barrel assembly towards the side of the barrel assembly as shown in FIGS. 3A and 5. These embodiments permit the projectiles exiting from the projectile bores 32 to penetrate a wider or longer section of the mole tunnel, thereby reducing the chances for the mole to escape being shot.

In the barrel assembly embodiments shown in FIGS. 3 and 4, a pellet or other projectile can be inserted into the ends 33 of the projectile bores 32 and pushed or otherwise moved along the projectile bore 22 to rest on the pellet stop, which can be arranged adjacent the explosion chamber 31. These ends 33 of the projectile bore 32 can have a diameter, shape, and/or configuration for holding a pellet of any shape or size therein, as discussed elsewhere in this application. The explosion chamber(s) 31 or the projectile bore 32 in the barrel assemblies in accordance with this application, such as those shown in FIGS. 4 and 5, can have a shape adapted to receive a bullet or shotgun shell. In such an arrangement, the explosion chamber(s) 31 or the projectile bore 32 are configured, so the lead or front portion of the bullet or cylindrical shell shot fits snugly therein. The casing of the bullet or cap of the shotgun shell is arranged to breach or span the diameter of the top of the explosion chamber or projectile bore. As shown in FIG. 5, a bullet 24 is mounted on the upper end of the projectile bore 32, in such a manner. Bullet casings and shotgun caps normally include at least a portion with a larger diameter than the bullet or shell body. The embodiments of the present application include resting the casing of the bullet or cap of the shotgun shell, as well as the casing of an explosive charge, outside the explosion chamber or projectile bore. In this manner, when the impingement device 18 strikes the casing of the bullet, the cap of the shotgun shell, or explosive charge; the gunpowder or other explosive or expansive material contained therein explodes forcing the bullet, shot, or pellet out of the end 33 of the projectile bore 32.

A spring 16 is arranged around the bar 15 and can be coaxial therewith. While a spring is shown in FIGS. 1 and 2, any type of biasing means can be used for generating a downward movement of the guide plate 17 from the armed position to the released position, even rubber bands. The biasing means should provide sufficient downward force to the guide plate 17, when released from the armed or set position, to cause an explosion by the guide plate (or impingement device 18 arranged thereon) impinging an explosive device arranged in the barrel assembly 19.

In another embodiment, the spring 16 is provided that has sufficient force, so that the impingement device 18 or firing pin will ignite or detonate the explosive charge. In other embodiments, the spring can be eliminated, where the weight of the guide plate 17, itself, or other force, is sufficient for igniting or detonating the explosive charge.

In a typical embodiment of the present application, the spring 16 forces the guide plate 17 downward, so that the impingement device 18 impacts the explosive charge contained in the explosion chamber 31 or projectile bore 32. The impact of the impingement device 18, such as a firing pin, with the explosive charge creates an explosion that generates downward force acting against the projectiles arranged within the projectile bores 32 (or fires bullet 24). The explosion occurs rapidly and forcefully to fire the bullet or projectile, so the mole has insufficient time to retreat in the tunnel and escape being shot.

In one embodiment described herein, a plunger- or spear-type trap can be adapted or modified into a mole gun in accordance with the discussions of this application. An embodiment of the present application includes parts and/or instructions, provided separately from a plunger- or spear-type trap, for adapting or modifying a plunger- or spear-type trap to a mole gun as described herein. These parts can include any of a barrel assembly 19, an impingement device 18, an extension plate 12, and appropriate fasteners and supports 20, 21 for securing these parts to a plunger- or spear-type trap. A plunger- or spear-type trap can be modified into a mole gun by removing or shortening the spikes or tines contained therein. For example, viewing the device shown in FIG. 6, the spines 109 can be removed or shortened. Shortened spines are shown on the guide plate 17 in FIG. 2. Additionally, a barrel assembly 19 and supports therefor 20, 21 in accordance with the discussions of this application can be arranged between the legs 104. Thereafter, an impingement device (i.e., firing pin) 18 can be arranged on the spear plate 106. Such a modification can be arranged as shown in FIG. 2 of the present application. When adapting or modifying a plunger- or spear-type trap, the spring can be shortened, replaced with a weaker spring, or eliminated altogether.

In view of the above, it will be seen that the several objects of the invention are achieved and other advantageous results attained. As various changes could be made in the above constructions without departing from the scope of the mole gun described in this application, it is intended that all matter contained in the above description or shown in the accompanying drawings shall be interpreted as illustrative and not in a limiting sense.

What is claimed is:

1. A mole gun for killing moles comprising:
a frame having upper and lower sections, the lower section for inserting and securing the mole gun into the ground and supporting the upper section in an upright position;
a bar extending vertically and passing through the frame, the bar having an upper end with a handle;
a guide plate slidably received along the frame and attached to a bottom end of the bar;
biasing means forcing the guide plate downward arranged about the bar between the guide plate and the frame;
an impingement device arranged on the guide plate on a side opposite the biasing means;
a barrel assembly secured to the frame for holding a powder charge and a projectile;
a latch for releasably holding the guide plate;
a trip plate arranged below the barrel assembly engaging with the latch for releasably holding the guide plate in a biased position.

2. The mole gun as set forth in claim 1, wherein an extension plate is arranged on the trip plate extending outwardly from the frame.

3. The mole gun as set forth in claim 1, wherein the barrel assembly includes an explosion chamber on a top thereof for holding an explosive charge.

4. The mole gun as set forth in claim 1, wherein the barrel assembly includes at least one projectile bore for holding the projectile.

5. The mole gun as set forth in claim 4, wherein the at least one projectile bore extends from a top of the barrel assembly to a bottom portion of the barrel assembly.

6. The mole gun as set forth in claim 5, wherein the at least one projectile bore is constructed to hold a bullet and the impingement device is constructed to strike the bullet upon downward movement thereof.

7. The mole gun as set forth in claim 3, wherein the barrel assembly includes at least one projectile bore for holding the projectile, and the least one projectile bore communicates with the explosion chamber.

8. The mole gun as set forth in claim 7, wherein the at least one projectile bore includes a pellet stop having a diameter smaller than that of the projectile bore.

9. The mole gun as set forth in claim 5, wherein the at least one projectile bore extends at an angle from an upper central portion of the barrel assembly to a lower outer portion of the barrel assembly.

10. The mole gun as set forth in claim 7, wherein the at least one projectile bore extends at an angle from an upper central portion of the barrel assembly to a lower outer portion of the barrel assembly.

11. A kit for adapting a spear mole trap including to a mole gun, which includes a barrel assembly for holding a powder charge and a projectile, a frame for securing the barrel assembly to a frame of the spear mole trap, an impingement device constructed to detonate the powdered charge and fire the projectile out of the barrel assembly, and means for securing the impingement device to a spear assembly of the spear mole trap.

12. The kit for adapting a spear mole trap to a mole gun as set forth in claim 11, further including an extension plate and means for securing the extension plate to a trip mechanism of the spear mole trap.

13. The kit for adapting a spear mole trap to a mole gun as set forth in claim 11, wherein the barrel assembly includes an explosion chamber on a top thereof for holding an explosive charge.

14. The kit for adapting a spear mole trap to a mole gun as set forth in claim 11, wherein the barrel assembly includes at least one projectile bore for holding the projectile.

15. The kit for adapting a spear mole trap to a mole gun as set forth in claim 14, wherein the at least one projectile bore extends from a top of the barrel assembly to a bottom portion of the barrel assembly.

16. The kit for adapting a spear mole trap to a mole gun as set forth in claim 15, wherein the at least one projectile bore is constructed to hold a bullet and the impingement device is constructed to strike the bullet upon downward movement thereof.

17. The kit for adapting a spear mole trap to a mole gun as set forth in claim 11, wherein the barrel assembly includes at least one projectile bore for holding the projectile, and the least one projectile bore communicates with the explosion chamber.

18. The kit for adapting a spear mole trap to a mole gun as set forth in claim 17, wherein the at least one projectile bore includes a pellet stop having a diameter smaller than that of the projectile bore.

19. The kit for adapting a spear mole trap to a mole gun as set forth in claim 15, wherein the at least one projectile bore extends at an angle from an upper central portion of the barrel assembly to a lower outer portion of the barrel assembly.

20. A barrel assembly for killing a mole comprising a three-dimensional structure that can withstanding an explosive charge, a top and bottom; at least one projectile bore extending from the top of the barrel assembly to the bottom of the barrel assembly; the projectile bore including first and second bore diameters for holding at least one of an explosive charge and a projectile.
